(19) United States
(12) Patent Application Publication
(10) Pub. No.: US 2024/0183666 A1
(43) Pub. Date: Jun. 6, 2024

(54) Providing Combined Map Information

(71) Applicant: Bayerische Motoren Werke Aktiengesellschaft, Muenchen (DE)

(72) Inventors: Michael FRENKEL, Jerusalem (IL); Vladimir HALTAKOV, Muenchen (DE); Andreas KOPP, Hoehenkirchen-Siegertsbrunn (DE)

(21) Appl. No.: 18/282,573

(22) PCT Filed: May 19, 2022
(86) PCT No.: PCT/EP2022/063500

§ 371 Date: Sep. 18, 2023

(30) Foreign Application Priority Data
Jul. 12, 2021 (DE) 10 2021 117 945.9

(51) Int. Cl. G01C 21/30; G01C 21/36

(52) U.S. Cl. CPC G01C 21/30; G01C 21/365

(57) ABSTRACT

A method for providing combined map information on board a vehicle includes determining a first mapping of a first map to an environment of the vehicle; determining a second mapping of a second map to the first map, wherein the second mapping maps the position of a landmark in the first map to a position of the same landmark in the second map; and providing information from the first and second maps relating to the surrounding area.

### BACKGROUND AND SUMMARY OF THE INVENTION

The invention relates to the provision of combined map information. In particular, the invention relates to the provision of information consisting of two different maps that refer to the same area.

A vehicle contains a head-up display (HUD), which is set up to enrich impressions from the immediate surroundings of the vehicle with stored information and present them to a driver. The information may come in particular from a map memory inn which a map is stored containing, for example, landmarks or roads in a predetermined area.

In a modern motor vehicle, various such maps can be held. For example, an initial map may be sufficiently accurate to allow automatic longitudinal and/or transverse control of the vehicle. This map needs to be updated constantly, which is why map information is usually only available updated for a limited horizon around the vehicle. A second map can be used for navigation of the vehicle and cover a wider area, such as a country, region or continent. A road network that is passable by the vehicle usually changes relatively slowly, so that the information on the second map can be up to date, which can be expressed in months. In addition, the second map is usually less detailed than the first and elements located in it have a position that can deviate further from reality than those of the first map.

It is often desirable to include information from both maps in the head-up display. For example, the position of a charging station from the second map and current information about a route closure from the first map could be displayed at the same time. For example, there are known approaches to conflation, which are called static referencing, dynamic referencing or location referencing. However, the conflation of information from different maps is generally time-consuming and error-prone and cannot always produce clear results.

An objective underlying the present invention is to indicate an improved technique for conflation of information of two different geographical maps. This objective is achieved by the claimed invention.

According to a first aspect of the present invention, a method for providing combined map information on board a vehicle includes steps of determining an initial mapping of a first map to the surroundings of the vehicle; determining a second mapping of a second map to the first map; wherein the second mapping maps the position of a landmark in the first map to a position of the same landmark in the second map; and the provision of information of the first map and the second map with respect to the surroundings.

An error between the two maps can be compensated by the difference in positions of the landmark in the two maps. In this way, improved information from the second map can be related to the first map. The information can then be jointly related to a reality surrounding the vehicle. A reverse approach, in which information from the first map is related to the second map, is also possible.

The mapping between the maps may require relatively low computational resources and may be performed in an acceptable time by a processing device on board the vehicle. Errors caused by the mapping may be minor. However, it should be noted that position information combined from the different maps can only have a precision corresponding to the precision of the information in the original map in each case.

Of course, the method can also be applied to multiple maps by concatenation or reference to a predetermined map. In the case of concatenation, a first map can be related to a second, which can be related to a third, and so on. In the second case, a first map can be used as a reference for a second, third, etc. A hybrid of both approaches is also possible.

It is generally preferred that the two maps have different characteristics. In particular, the maps may differ in terms of accuracy, detail or timeliness. In a preferred embodiment, the first map is set up for controlling the vehicle with respect to its surroundings and the second map is set up for navigating the vehicle on a road network. Both maps can be vector maps. The first map can be more up-to-date and detailed than the second map. In addition, the accuracy of positions of objects in the second map can be higher than the accuracy of positions of objects in the first map. It is usual for information about specific objects to be saved in both maps. However, with the exception of the landmarks, this is not essential.

It is also preferable that the maps each have a high relative accuracy. In other words, it is preferable that positions of the landmarks in the maps match the positions of other objects in the same map. For example, distances between the landmark and other landmarks in the same map can relatively closely match distances between the corresponding objects in the reality. An average or maximum deviation of the distances from the real distances can be referred to as relative accuracy.

Absolute precision, on the other hand, refers to a maximum or average distance of a position of a landmark in one of the maps from the position of the landmark in reality. Relative accuracies of the two maps can be significantly higher than absolute accuracies. In particular, it is preferred that relative accuracies in the two maps are less than about 5 m; more preferably less than about 1 m. Absolute accuracies can be significantly greater, in the case of the second map, a positional deviation from reality of multiple 10's, multiple 50's or multiple 100's of m can be tolerable.

The second mapping may be determined on the basis of a deviation of positions of a landmark between the two maps. Positions of further information on one map, which are related to the other map, can acquire an absolute accuracy via second mapping that can correspond to the relative accuracy. In particular, the mapping may involve a shift in the north-south direction and/or in the east-west direction.

It is particularly preferable that the second mapping is based on deviations of positions of multiple landmarks between the two maps. The landmarks can be located within a predetermined maximum distance from a position of the vehicle. By taking into account multiple landmarks, a more accurate second mapping can be determined. In addition, the second mapping may include additional transformations, in particular a rotation, a shear, a stretching or a compression.

Since absolute deviations between the maps are usually not constant over the scope of the maps, it is particularly possible to consider landmarks the distance of which from the position of the vehicle is less than about 100 m, for example. In one embodiment, only landmarks that are not further away than can be determined from the vehicle by way of optical sensors are considered. In particular, if the information of the first and second maps is to be presented to a person on board the vehicle, it is already possible in this way to exclude information that is outside a person's field of view. By choosing a relatively small maximum distance, the accuracy of the second mapping can be maximized without having to discard relevant information to be displayed.

The landmarks in the two maps can be determined in any way. A landmark can be classified, for example as a signpost or street marker, or unclassified, for example as a general elongated object, as an edge, tree, street lamp, wall, corner of a house, etc. A landmark can also contain a number of points, such as were detected by way of a radar or LiDAR sensor. These points usually form some accumulation that is distinguishable from other objects or signal noise.

In one embodiment, a position of a landmark in a map is determined on the basis of a number of observations of the landmark by vehicles and respective determined positions of the vehicles. For example, records of the landmark can be collected from a large number of vehicles in a vehicle fleet and used as a basis for creating the map. For each observation, a position of the landmark can be determined with respect to the respective position of the vehicle, so that there is an absolute position of the landmark.

It is also preferred that mutually corresponding landmarks in the maps each bear the same identifier. The determination of mutually corresponding landmarks in the two maps can thus be carried out quickly and unambiguously. Identifiers can be assigned uniformly by a central station. For example, the station that collects observations of the number of vehicles can assign the identifiers. Incorrect determinations or relationships that cannot be established between mutually corresponding landmarks in the two maps can be avoided as a result.

In another embodiment, the landmarks in one of the maps are each assigned additional information that allows the identifier of the landmark to be determined in the other map. Thus, a system of identifiers that a producer of the map uses for included landmarks or other objects, can be made more use of. For example, the note can be stored in a predetermined layer of the map. In particular, the note may include the identifier of the target map, multiple identifiers of different target maps, a mapping rule or a reference to a conversion service, which converts identifiers of one map into identifiers of another map.

The information of the first map and the information of the second map can be represented to a person on board the vehicle in the immediate spatial context for an object to which they refer. This representation can be carried out exactly by the first mapping. The information can extend, supplement, or overlay the object.

It is particularly preferable that the information should be represented in the manner of an extended reality relative to the object. In a further development, for example, a representation in the manner of an artificial reality is also possible, in which a direct consideration of the surroundings does not take place.

In a further embodiment, a mapping rule is created by the method for mapping a landmark in one of the maps to a landmark in the other map. For example, the mapping rule can include a table or be implemented as a service that can be automatically called by any device that is working with one of the maps.

The conflation of the maps determined by the method can be used to offer another service outside a vehicle, for example the determination of a route which has predetermined characteristics with respect to both maps. In one variant, a processing of mass data can be supported by, for example, determining a probability of a free parking space within a predetermined distance for a location on the first map on the basis of information from the second map.

According to a second aspect of the present invention, an apparatus contains an apparatus for scanning the surroundings of the vehicle for the provision of combined map information on board a vehicle; and a processing device. In this case, the processing device is set up to determine an initial mapping of a first map to the surroundings of the vehicle; to determine a second mapping of a second map to the first map; and to provide information about the first map and the second map with respect the surroundings.

The apparatus may be set up to perform all or part of any method described herein. For this purpose, the apparatus can use a processing device that contains a programmable microcomputer or microcontroller. The method can be in the form of a computer program product with program code. The computer program product may also be stored on a computer-readable data carrier. Features or advantages of the method can be transferred to the apparatus or vice versa.

In a more preferred embodiment, the device also contains a head-up display for representing the information about the surroundings to a person on board the vehicle. The vehicle may include, in particular, a motor vehicle, such as a motorcycle, a passenger car, a truck or a bus. In particular, the person may include a driver of the vehicle or motor vehicle.

According to yet another aspect of the present invention, a vehicle contains an apparatus described herein.

Exemplary embodiments of the invention are now described in more detail with reference to the attached drawings.

### BRIEF DESCRIPTION OF THE DRAWINGS

FIG. 1 shows a vehicle with an apparatus with two maps.

FIG. 2 shows by way of example first and second mappings between two maps and a reality.

FIG. 3 shows by way of example mappings between maps.

FIG. 4 shows a flow chart of a method.

### DETAILED DESCRIPTION OF THE DRAWINGS

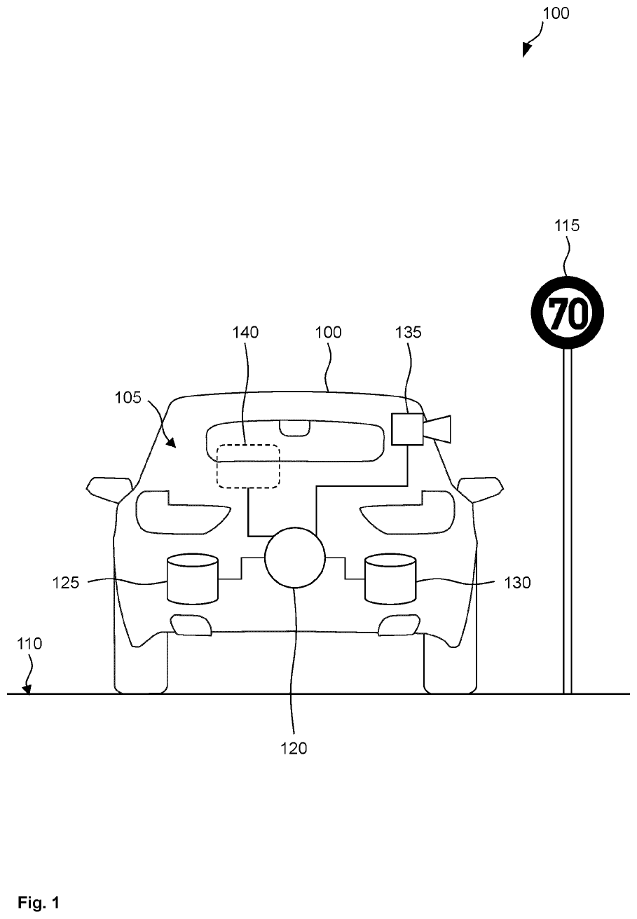

FIG. 1 shows a vehicle 100 with an apparatus 105. The vehicle 100 is driving on a road 110, in the vicinity of which there is a landmark 115. The landmark 115 can include, for example, a traffic sign, an information sign, a lane marking, a place sign or a different object preferably located very close to the road 110, the position of which can be determined at a point which is not mobile and is expected to last for a predetermined period of time. This time can be expressed in weeks or months, for example.

The apparatus 105 preferably comprises a processing device 120, a first map memory 125 for holding a first map, a second map memory 130 for holding a second map, a scanning device 135 for scanning the surroundings of the vehicle 100 and an output device 140 for providing information about one or both maps.

The maps are geographical maps that contain information about objects in the surroundings of the vehicle 100. In one embodiment, both maps are stored in the same map memory. The maps usually differ from each other in terms of accuracy, timeliness, detail, or area covered. It is further preferred that the maps are provided by different producers so that they are as independent of each other as possible.

The scanning device 135 can be used on the one hand to determine a geographical position of the vehicle 100 in the reality, and on the other hand to determine the position of a landmark 115 with respect to the vehicle 100. For example, the scanning device 135 may contain a camera, a LiDAR sensor or a radar sensor. In a further embodiment, the scanning device 135 contains a positioning device, in particular a receiver for signals from a satellite-based navigation system. Other sensing devices, such as an odometer or an inertial platform, may also be included.

The output device 140 is set up to provide information to a person on board the vehicle 100. In particular, this person may include a driver of the vehicle 100. In a particularly preferred embodiment, the output device 140 contains a head-up display, which is designed to overlay or combine a view of the surroundings that can be directly perceived by the driver with additional visual information. In another embodiment, the output device 140 may also be in the form of an interface set up to connect to another system on board the vehicle 100.

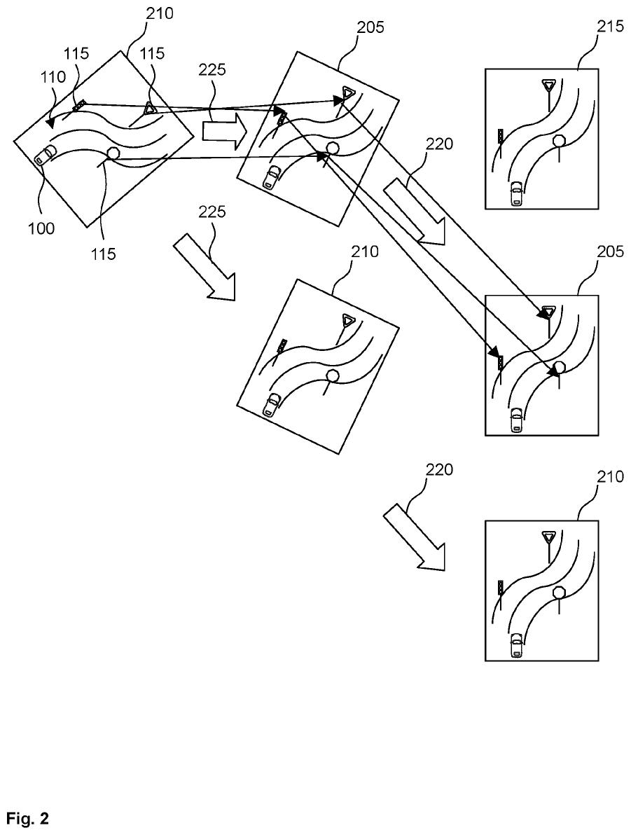

FIG. 2 shows exemplary mappings between maps and a reality in the surroundings of a vehicle 100. FIG. 2 considers an area comprising the vehicle 100, an example of a road 110 and multiple examples of landmarks 115. FIG. 2 shows multiple such areas, each relating to a first map 205, a second map 210 or a reality 215. The reality 215 may be determined by absolute and objective positions of objects with respect to a predetermined geoid such as WGS 84.

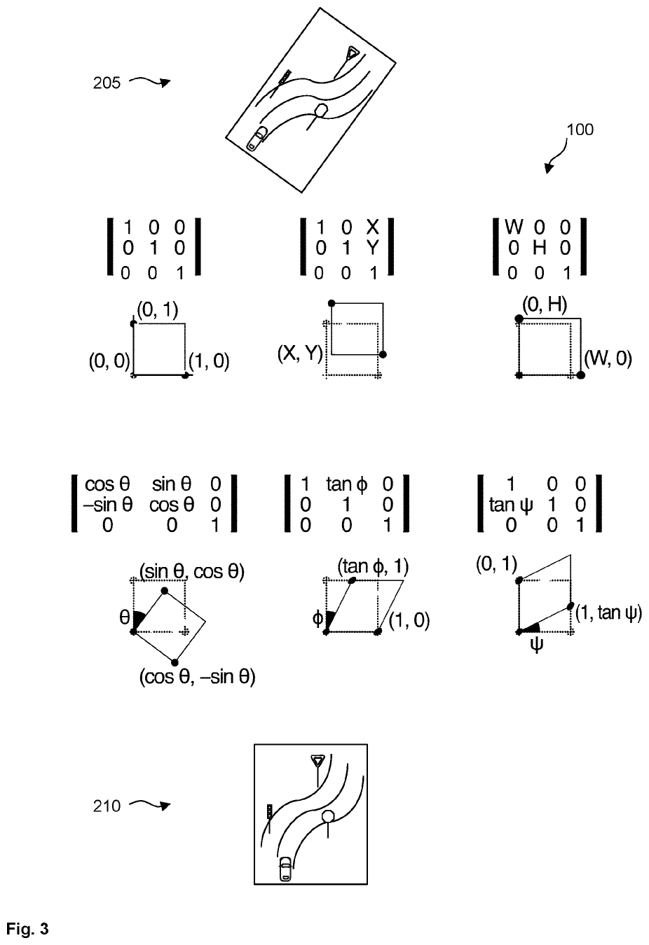

Positions of the landmarks 115 in the different areas differ from each other. A first mapping 220 brings the first map 205 into conformity with the reality 215. For this purpose, the positions of the landmarks 115 are determined in the first map 205 and in the reality 215 respectively, and the first mapping 220 is determined on the basis of deviations of the positions. In the present representation, the first mapping 220 comprises only one rotation; as shown in more detail in FIG. 3, other mappings can also be carried out. A second mapping 225 is similarly determined to bring the second map 210 into conformity with the first map 205. In both maps 205 and 210, landmarks 115 are determined which correspond to each other and for the two landmarks 115 a difference in their geographical position indicated in the respective map 205, 210 is determined. The second mapping 225 can be determined on the basis of position differences of one or more landmarks 115.

By applying the second mapping 225 to the second map 210, the maps 205 and 210 can be made comparable. In particular, indicated positions of landmarks 115 in the two maps 205 and 210 may be the same. Positional information of the first map 205 can be expressed in relation to the second map 210 and vice versa.

In particular, information about an object that is shown in only one of the two maps 205, 210 can be transferred to the other map. By way of the first mapping 220, the information of the two maps 205, 210 can be brought into conformity with the reality 215. Thus, information given about any of the elements specified in maps 205 and 210 can be provided or displayed relative to the reality 215.

FIG. 3 shows exemplary mappings 220, 225 between a first map 205 and a second map 210. The mappings 220, 225 can be carried out in particular by way of matrix operations, since the maps 205, 210 relate approximately to points in a plane. If elevation information is also relevant, then suitable multidimensional transformations can be applied.

Six examples of the transition between the first map 205 and the second map 210 are represented arranged in two rows and three columns. In each example, a mapping matrix is shown at the top and an indication of the operation is shown at the bottom, with reference to a square symbolizing one of the maps 205, 210. The result of the transformation to the square is also shown.

In the first row, from left to right, a first example shows the identity. The first map 205 is mapped unchanged to the second map 210. A second example shows the shift. The first map 205 is moved horizontally by the amount x and in the vertical direction by the amount y to be mapped to the second map 210. A third example describes scaling. The first map 205 is stretched horizontally by a factor w and vertically by a factor h to be mapped to the second map 210. If a reduction is desired, the corresponding parameter w or h must be selected between O and 1. No scaling occurs when the w or h parameter equal to 1 is selected.

In the second row, from left to right, a first example shows a rotation by an angle Θ is shown. A second example shows shear in the horizontal direction by an angle Φ. A third example shows a shear in the vertical direction by an angle Ψ.

It should be noted that multiple mappings can also be combined in a mapping matrix. The mapping matrix maps the first map 205 to the second map 210; for mapping in the opposite direction, the mapping matrix can be inverted accordingly.

It should also be noted that a mapping of one map to another can also be carried out by way of another mapping or can be indicated in a different way. For example, a parametric mapping can be determined, which takes into account that a mapping rule from the first map to the second map depends on the location considered in the first map. In particular, the mapping can be non-linear depending on the location.

A mapping at a predetermined location from the first map to the second map can be determined on the basis of the parametric specification. In particular, a mapping matrix for a predetermined location can be formed dynamically. In another embodiment, the parametric specification can accept the location as an additional parameter for carrying out the mapping itself.

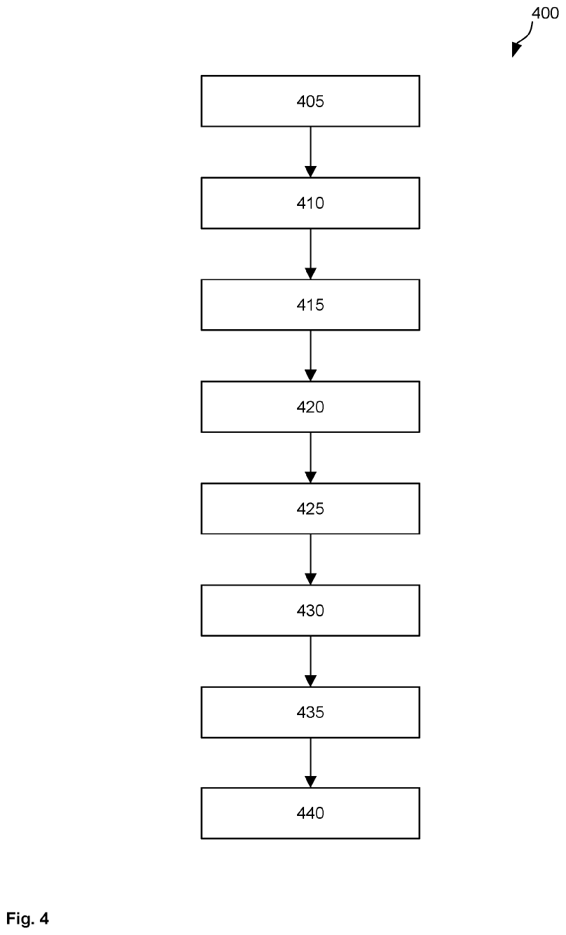

FIG. 4 shows a flowchart of an exemplary method 400 for providing combined map information from two different maps 205, 210.

In a step 405, the surroundings of the vehicle 100 can be scanned. One or more landmarks 115 can be determined and set in relation to corresponding landmarks of the first map 205. In a step 410, a first mapping 220 can be determined in order to bring landmarks shown in the first map 205 in alignment with observed landmarks as far as possible.

Similarly, a second mapping can be determined for mapping the second map 210 to the first map 205. In a step 415, a first position of a landmark 115 on the first map 205 can be determined. In a step 420, a second position of the same landmark 115 on the second map 210 can be determined. These determinations may be carried out with respect to multiple landmarks 115 in predetermined surroundings around the vehicle 100. In a step 425, the second mapping 225 can be determined. In particular, the mapping can perform operations such as a shift, a scaling, a rotation, or a shear.

Preferably, the second mapping 225 is specified in the form of a mapping matrix.

In a step 430, the maps 205, 210 can be mapped to the reality 215 according to the scanning in step 405. For this purpose, the second map 210 can be brought into coincidence with the first map 205 by way of the second mapping 225 and then both maps 205, 210 can be brought into coincidence with the reality 215 on the basis of the first mapping 220.

In a step 435, information can be determined which is specified in the two maps 205, 210 in the surroundings of the vehicle 100. This information can be processed, superimposed, coordinated or otherwise put into context with each other in a step 440. In addition, the information can be provided on board the vehicle 100. For this purpose, the information can be output visually to a person on board the vehicle 100 in the manner of an augmented reality, in particular by way of a head-up display 140.

### REFERENCE SIGNS

100 Vehicle
105 Apparatus
110 Road
115 Landmark
120 Processing device
125 First map memory
130 Second map memory
135 Scanning device
140 Output device
205 First map
210 Second map
215 Reality/scan of the surroundings
220 First mapping
225 Second mapping
400 Method
405 Scanning the surroundings
410 Determining first mapping
415 Determining first position of landmark on first map
420 Determining second position of landmark on second map
425 Determining second mapping
430 Mapping maps to surroundings
435 Determining information
440 Determining information

1.-12. (canceled)

13. A method for providing combined map information on board a vehicle, the method comprising:
determining a first mapping of a first map to surroundings of the vehicle;
determining a second mapping of a second map to the first map, wherein the second mapping maps a position of a landmark in the first map to a location of the landmark in the second map; and
providing information from the first map and the second map with respect to the surroundings.

14. The method as claimed in claim 13, wherein the first map is configured for controlling the vehicle with respect to the surroundings and the second map is configured for navigating the vehicle on a road network.

15. The method as claimed in claim 13, wherein positions of the landmark in the maps match positions of other objects in the maps.

16. The method as claimed in claim 15, wherein the second mapping is determined based on deviations of positions of multiple landmarks between the maps.

17. The method as claimed in claim 15, wherein a position of a respective landmark in one of the maps is determined based on a plurality of observations of the respective landmark by vehicles and determined positions of the vehicles.

18. The method as claimed in claim 15, wherein mutually corresponding landmarks in the maps each bear a same identifier.

19. The method as claimed in claim 18, wherein the landmarks in one of the maps each have additional assigned information which allows a determination of the identifier of the landmark in the other map.

20. The method as claimed in claim 13, wherein the information from the first map and the second map is presented to a person on board the vehicle in an immediate spatial context of an object to which the information relates.

21. The method as claimed in claim 20, wherein the information is presented in a manner of an extended reality with respect to the object.

22. An apparatus for providing combined map information on board a vehicle, the apparatus comprising:
a device for scanning surroundings of the vehicle; and
a processing device which is configured:
to determine a first mapping of a first map to the surroundings of the vehicle;
to determine a second mapping of a second map to the first map; and
to provide information about the surroundings from the first map and the second map.

23. The apparatus as claimed in claim 22, further comprising a head-up display for providing the information about the surroundings to a person on board the vehicle.

24. A vehicle comprising the apparatus as claimed in claim 22.
